(19) United States
(12) Patent Application Publication
(10) Pub. No.: US 2012/0120322 A1
(43) Pub. Date: May 17, 2012

(54) PORTABLE WIRELESS DEVICE

(75) Inventors: Hiroshi Satou, Kanagawa (JP); Yoshio Koyanagi, Kanagawa (JP); Yoshihiro Kanasaki, Ishikawa (JP)

(73) Assignee: PANASONIC CORPORATION, Osaka (JP)

(21) Appl. No.: 13/381,866

(22) PCT Filed: Mar. 2, 2010
(86) PCT No.: PCT/JP10/01424

§ 371 Date: Dec. 30, 2011

(30) Foreign Application Priority Data
Jul. 6, 2009 (JP) 2009-159839

(51) Int. Cl. H04N 5/455

(52) U.S. Cl. 348/726; 348/E05.108; 348/E05.113

(57) ABSTRACT

Disclosed is a portable wireless device which can receive signals at a wideband with good sensitivity, and change a narrowband wherein signals are received with high sensitivity. In this device, a wireless unit (105) demodulates signals received by an antenna (101) or modulates signals to be transmitted by the antenna (101). Matching circuits (103-1 to 103-n) are connected between the antenna (101) and the wireless unit (105) and match impedance so that the impedance of the antenna (101) and the impedance of the wireless unit (105) have a complex conjugate relation. A plurality of these are respectively provided for a plurality of different frequency bands where matching is performed.

### TECHNICAL FIELD

The present invention relates to a portable radio apparatus, and especially relates to a portable radio apparatus that enables matching in a wideband, as well as varying frequency by which matching is enabled in a narrowband.

### 2. BACKGROUND ART

Conventionally, a portable radio apparatus provided with a plurality of matching circuits for matching characteristic impedances of 50Ω, and that adapts to a wideband by switching the plurality of matching circuits is known (see e.g., Patent Literature 1). According to Patent Literature 1, by switching connections of two types of matching circuits and one antenna element by using diode switches, a matched state for two types of frequency characteristics is obtained, and an adaptation thereof to a radio system of the wideband is performed. Further, in Patent Literature 1, it has a premise that the antenna and a radio section are connected by the characteristic impedance of 50Ω.

Further, conventionally, a portable radio apparatus that performs matching such that an impedance of the antenna and an input impedance of an amplifier have a complex conjugate relationship is known (see e.g., Patent Literature 2). According to Patent Literature 2, matching in the wideband is enabled by providing an impedance converting circuit that connects in parallel by ground connection between the antenna and a transistor.

### Citation List

### Patent Literature

### PTL 1

Japanese Patent Application Laid-Open No. 2007-325147

### PTL 2

Japanese Patent Application Laid-Open No. 2007-295459

### SUMMARY OF INVENTION

### Technical Problem

However, since Patent Literature 1 uses the plurality of matching circuits that performs the characteristic impedance matching of 50Ω by switching the same, the frequency to be matched by the respective matching circuits is a narrowband. Consequently, Patent Literature 1 has problems that the number of the matching circuits needs to be increased to cover the wideband characteristics, and in addition, the wideband characteristics have to be obtained by the antenna element. Further, in Patent Literature 1, in a case where frequency that cannot be matched due to the limitation on the number of the matching circuits that can be installed, etc. existing, there is a problem that it is not possible to operate the radio system using the frequency that cannot be matched. Further, in Patent Literature 2, since it is not possible to change the frequency by which the matching can be obtained, there is a problem that it is not possible to deal with cases in which the frequency having a large matching loss or a scarce matching loss changes.

The present invention aims to provide a portable radio apparatus that can receive signals in the wideband with satisfactory sensitivity, and change the narrowband by which the signals are received with high sensitivity.

### Solution to Problem

A portable radio apparatus of the present invention employs a configuration including an antenna; a radio section that performs demodulation of a signal received by the antenna or modulation of a signal to be sent by the antenna; and a plurality of matching circuits, each of which is connected between the antenna and the radio section, performs matching such that an impedance of the antenna and an impedance of the radio section have a complex conjugate relationship, and is provided for each of the different frequency bands in which the matching is to be performed.

### Advantageous Effects of Invention

According to the present invention, it is possible to receive signals with satisfactory sensitivity in the wideband, and it is possible to change the narrowband by which the signals are received with high sensitivity.

### BRIEF DESCRIPTION OF DRAWINGS

FIG. 1 is a block diagram showing a configuration of a portable radio apparatus of Embodiment 1 of the present invention;

FIG. 2 is a block diagram showing the first example of a configuration of a matching circuit of Embodiment 1 of the present invention;

FIG. 3 is a block diagram showing the second example of a configuration of the matching circuit of Embodiment 1 of the present invention;

FIG. 4 is a block diagram showing the third example of a configuration of the matching circuit of Embodiment 1 of the present invention;

FIG. 5 is a block diagram showing the fourth example of a configuration of the matching circuit of Embodiment 1 of the present invention;

FIG. 6 is a block diagram showing the fifth example of a configuration of the matching circuit of Embodiment 1 of the present invention;

FIG. 7 is a diagram showing an operation of the portable radio apparatus of Embodiment 1 of the present invention;

FIG. 8 is a diagram for explaining matching by which a complex conjugate relationship can be obtained in a Smith chart of Embodiment 1 of the present invention;

FIG. 9 is a diagram showing a relationship of frequency and loss in the case of providing a plurality of conventional matching circuits for matching characteristic impedances of 50Ω;

FIG. 10 is a diagram showing a relationship of frequency and loss in Embodiment 1 of the present invention;

FIG. 11 is a diagram showing a conventional relationship of mismatch loss and frequency in viewing two channels of digital television broadcast;

FIG. 12 is a diagram showing a relationship of mismatch loss and frequency in viewing two channels of digital television broadcast in Embodiment 1 of the present invention;

FIG. 13 is a diagram showing a conventional relationship of number of matching circuits and bands by which matching can be obtained;

FIG. 14 is a diagram showing a relationship of the number of matching circuits and bands by which matching can be obtained in Embodiment 1 of the present invention;

FIG. 15 is a block diagram showing a configuration of a portable radio apparatus of Embodiment 2 of the present invention;

FIG. 16 is a block diagram showing a configuration of a portable radio apparatus of Embodiment 3 of the present invention;

FIG. 17 is a diagram showing a relationship of frequency and loss in the first radio system and the second radio system that are capable of receiving signals in Embodiment 3 of the present invention;

FIG. 18 is a block diagram showing a configuration of a portable radio apparatus of Embodiment 4 of the present invention;

FIG. 19 is a diagram showing changes in an impedance matching point of the first radio system and the second radio system in a Smith chart in Embodiment 4 of the present invention;

FIG. 20 is a block diagram showing a configuration of a portable radio apparatus of Embodiment 5 of the present invention;

FIG. 21 is a block diagram showing a configuration of a matching circuit of Embodiment 5 of the present invention;

FIG. 22 is a block diagram showing a configuration of a portable radio apparatus of Embodiment 6 of the present invention;

FIG. 23 is a block diagram showing the first example of a configuration of a matching circuit of Embodiment 6 of the present invention;

FIG. 24 is a block diagram showing the second example of a configuration of the matching circuit of Embodiment 6 of the present invention;

FIG. 25 is a block diagram showing the third example of a configuration of the matching circuit of Embodiment 6 of the present invention;

FIG. 26 is a block diagram showing the fourth example of a configuration of the matching circuit of Embodiment 6 of the present invention; and

FIG. 27 is a block diagram showing the fifth example of a configuration of the matching circuit of Embodiment 6 of the present invention.

### DESCRIPTION OF EMBODIMENTS

Hereinbelow, the embodiments of the present invention will be described in detail with reference to the drawings.

### Embodiment 1

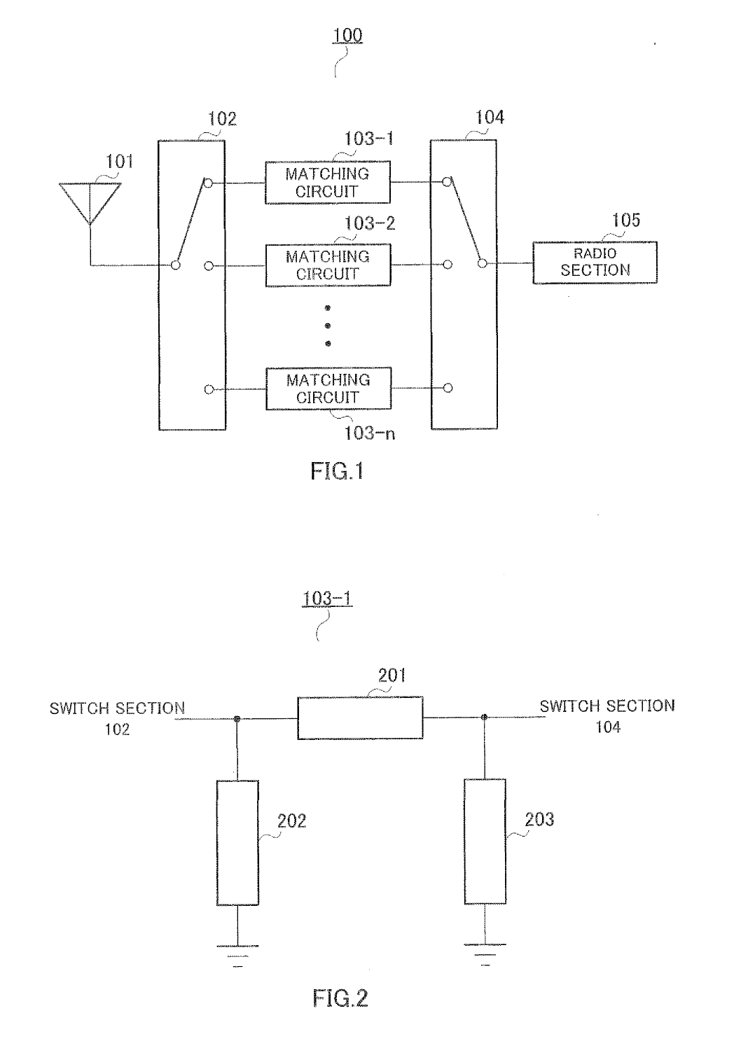

FIG. 1 is a block diagram showing a configuration of portable radio apparatus 100 of Embodiment 1 of the present invention.

Portable radio apparatus 100 is configured primarily with antenna 101, switch section 102, matching circuits 103-1 to 103-n (n being an arbitrary natural number), switch section 104, and radio section 105. Hereinbelow, each configuration will be described in detail.

Antenna 101 functions e.g. as a monopole antenna, and includes an antenna element with an electrical length of a quarter wavelength or less. Further, antenna 101 receives a signal from a specific radio system, and outputs the same to switch section 102. Further, antenna 101 sends the signal of the specific radio system input from switch section 102.

Switch section 102 switches output of the signal input from antenna 101 to specific one of matching circuits 103-1 to 103-n. Further, switch section 102 selects one of matching circuits 103-1 to 103-n, and switches output of the signal input from the selected one of matching circuits 103-1 to 103-n to antenna 101.

Matching circuits 103-1 to 103-n are connected serially between switch section 102 and switch section 104, and match impedances of antenna 101 and radio section 105. Specifically, matching circuits 103-1 to 103-n perform matching such that the impedance of antenna 101 and the input impedance of radio section 105 have a complex conjugate relationship. At this occasion, each of matching circuits 103-1 to 103-n performs matching so that the complex conjugate relationship can be obtained in the respective, different frequencies. Accordingly, by switching matching circuits 103-1 to 103-n, it is possible to vary the frequency by which the complex conjugate relationship can be obtained. Further, matching circuits 103-1 to 103-n convert the impedance of the signal input from switch section 102 and output the same to switch section 104. Similarly, matching circuits 103-1 to 103-n match the impedance of antenna 101 and the output impedance of radio section 105 to have the complex conjugate relationship, convert the impedance of the signal input from switch section 104 and output the same to switch section 102.

Switch section 104 selects one of matching circuits 103-1 to 103-n, and switches output of the signal input from the selected one of matching circuits 103-1 to 103-n to radio section 105. Further, switch section 104 switches output of the signal input from radio section 105 to specific one of matching circuits 103-1 to 103-n. Further, switch section 104 selects one of matching circuits 103-1 to 103-n that is identical to the one of matching circuits 103-1 to 103-n selected by switch section 102. The method of selecting matching circuits 103-1 to 103-n will be described later.

Radio section 105 obtains data that is superimposed at a specific frequency by demodulating the signal input from switch section 104. Further, radio section 105 modulates the signal to superimpose data at the specific frequency, and outputs the modulated signal to switch section 104. At this occasion, at radio section 105, the input impedance and the output impedance at switch section 104 side are complex impedances and are at the same time high impedances.

Next, the configuration of matching circuits 103-1 to 103-n will be described. In the explanation of the configuration of matching circuits 103-1 to 103-n hereinbelow, only matching circuit 103-1 will be described; since the configuration of matching circuits 103-2 to 103-n is identical to that of matching circuit 103-1, the explanation of the configuration of matching circuits 103-2 to 103-n will not be repeated.

FIG. 2 is a block diagram showing the first example of the configuration of matching circuit 103-1.

As shown in FIG. 2, matching circuit 103-1 is configured with element 201, element 202, and element 203. Elements 201 to 203 are inductors or capacitors.

Element 201 has its one end connected to switch section 102 and its other end connected to switch section 104.

Element 202 is connected by ground connection in parallel between switch section 102 and element 201.

Element 203 is connected by ground connection in parallel between switch section 104 and element 201.

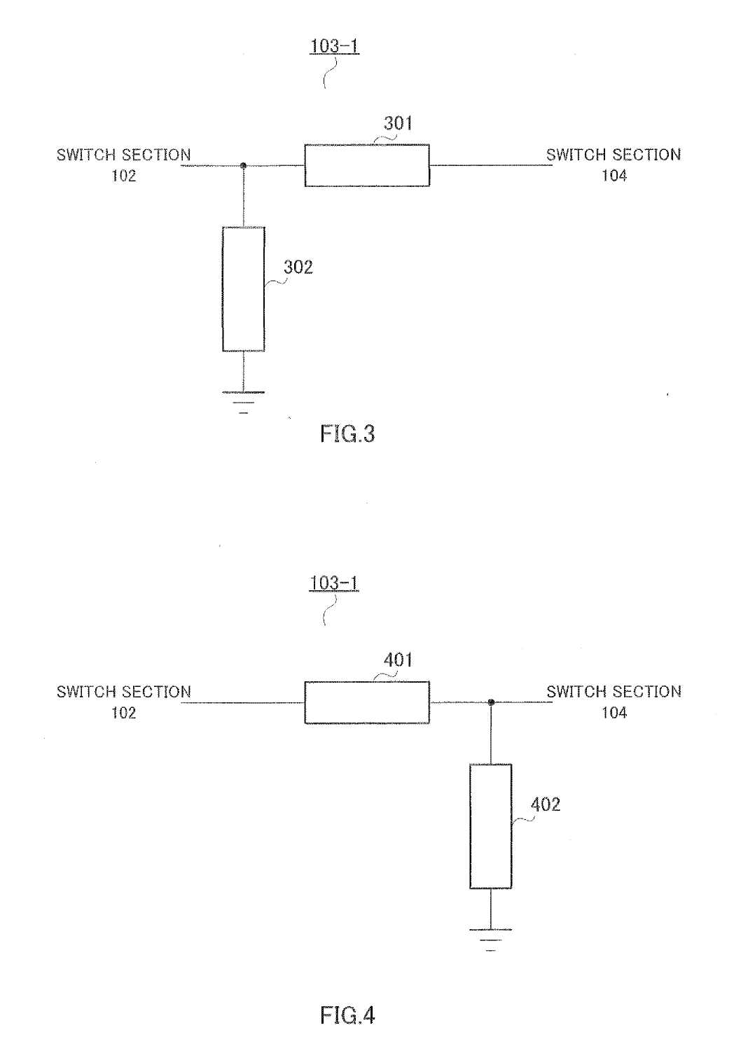

FIG. 3 is a block diagram showing the second example of a configuration of matching circuit 103-1.

As shown in FIG. 3, matching circuit 103-1 is configured with element 301 and element 302. Elements 301 and 302 are inductors or capacitors.

Element 301 has its one end connected to switch section 102 and its other end connected to switch section 104.

Element 302 is connected by ground connection in parallel between switch section 102 and element 301.

FIG. 4 is a block diagram showing the third example of a configuration of matching circuit 103-1.

As shown in FIG. 4, matching circuit 103-1 is configured with element 401 and element 402. Elements 401 and 402 are inductors or capacitors.

Element 401 has its one end connected to switch section 102 and its other end connected to switch section 104.

Element 402 is connected by ground connection in parallel between element 401 and switch section 104.

FIG. 5 is a block diagram showing the fourth example of a configuration of matching circuit 103-1.

As shown in FIG. 5, matching circuit 103-0.1 is configured with element 501 and element 502. Elements 501 and 502 are inductors or capacitors.

Element 501 is connected by ground connection in parallel between switch section 102 and switch section 104.

Element 502 is connected by ground connection in parallel between switch section 102 and switch section 104, and is connected by ground connection in parallel with element 501.

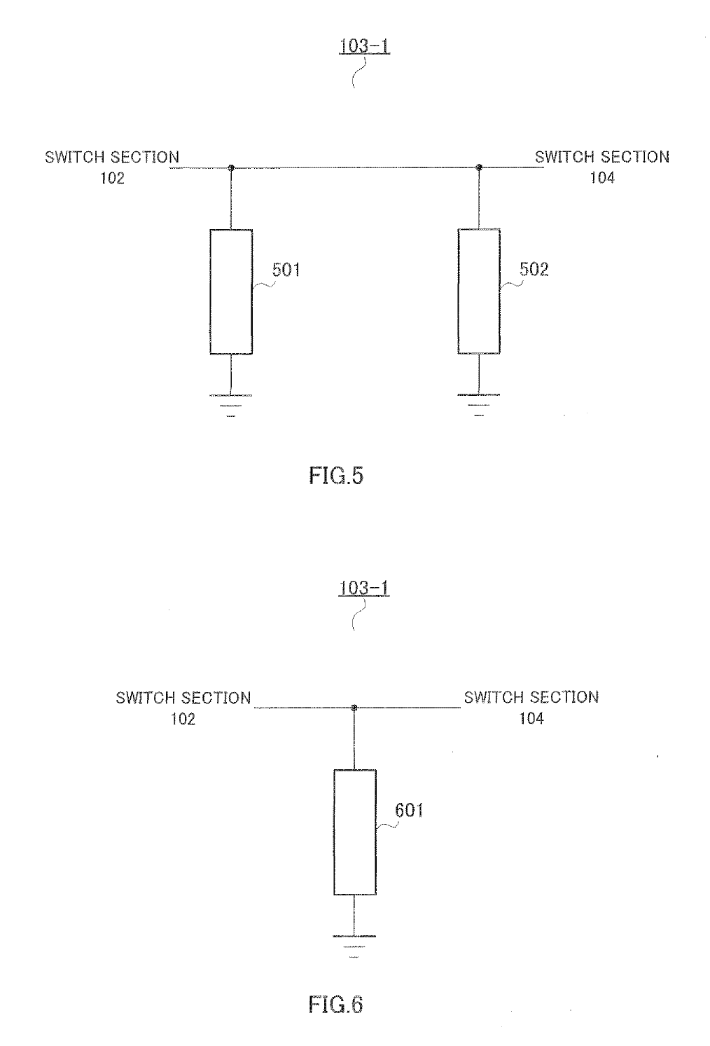

FIG. 6 is a block diagram showing the fifth example of a configuration of matching circuit 103-1.

As shown in FIG. 6, matching circuit 103-1 is configured with element 601. Element 601 is an inductor or a capacitor.

Element 601 is connected by ground connection in parallel between switch section 102 and switch section 104. The configuration of portable radio apparatus 100 has been described above.

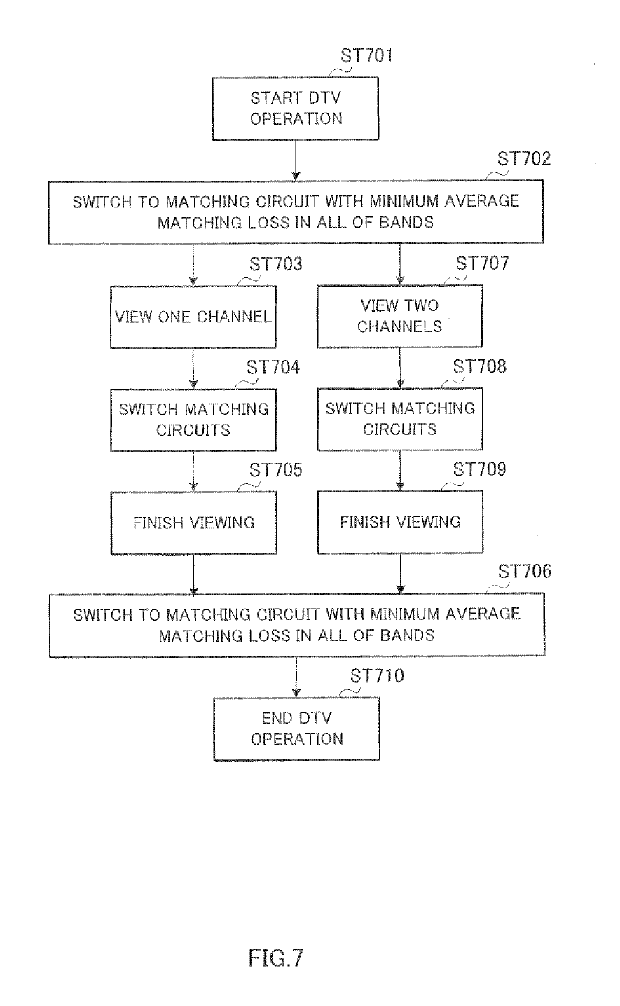

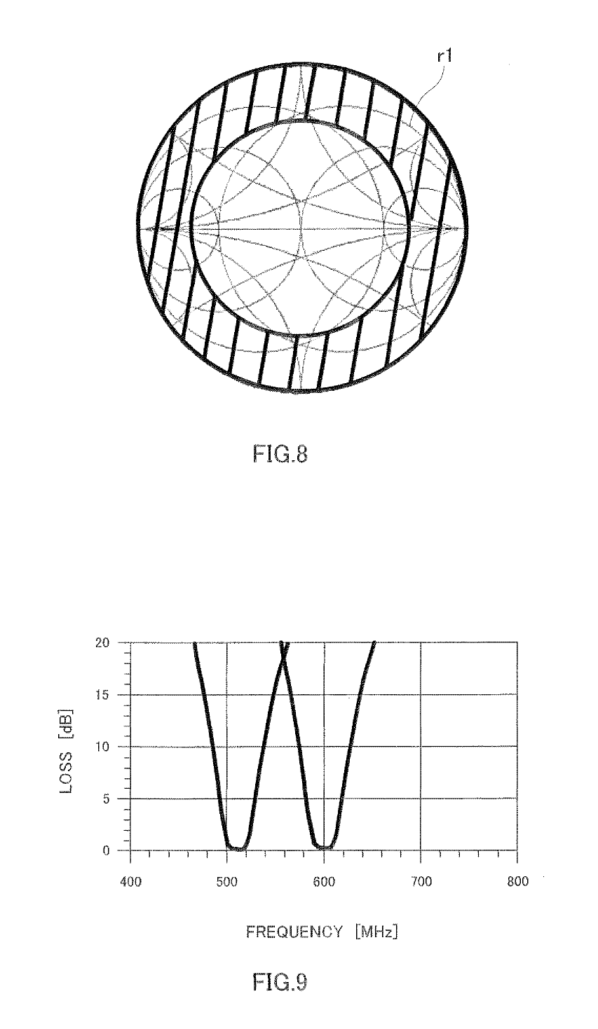

Next, an operation of portable radio apparatus 100 will be described with reference to FIG. 7. FIG. 7 is a diagram showing the operation of portable radio apparatus 100. FIG. 7 shows the operation of portable radio apparatus 100 in the case of receiving digital television broadcast.

Portable radio apparatus 100 retains in advance a table storing the matching loss in using each of matching circuits 103-1 to 103-n in all of the channels of the digital television broadcast.

Firstly, portable radio apparatus 100 starts an operation of receiving digital television broadcast (step ST701).

Next, switch section 102 and switch section 104 switch to connect to matching circuits 103-1 to 103-n in which the average matching loss becomes minimum in all of the bands of each channel of the digital television broadcast (step ST702).

Next, in the case of viewing only one channel (step ST703), switch section 102 and switch section 104 switch to connect to matching circuits 103-1 to 103-n in which the average matching loss becomes minimum in the frequency of the viewing channel (step ST704).

Next, in the case of stopping the viewing (step ST705), switch section 102 and switch section 104 switch to connect to matching circuits 103-1 to 103-n in which the average matching loss becomes minimum in all of the bands of each channel of the digital television broadcast (step ST706).

Further, in the case of viewing two channels (step ST707), switch section 102 and switch section 104 switch to connect to matching circuits 103-1 to 103-n in which the matching loss in the frequency of the channel that is mainly viewed is smaller than the matching loss in the frequency of the other channel being viewed, and in addition to this, the total of the matching losses of both channels becomes minimum (step ST708).

Next, in the case of stopping the viewing (step ST709), switch section 102 and switch section 104 switch to connect to matching circuits 103-1 to 103-n in which the average matching loss becomes minimum in all of the bands of each channel of the digital television broadcast (step ST706).

Further, after having switched to connect to matching circuits 103-1 to 103-n in which the average matching loss becomes minimum in all of the bands of each channel of the digital television broadcast in step ST706, portable radio apparatus 100 ends the digital television broadcast operation (step ST710). The operation of portable radio apparatus 100 has been described above.

FIG. 8 is a diagram for explaining matching by which the complex conjugate relationship can be obtained in a Smith chart. The matching by which the complex conjugate relationship can be obtained means that, with respect to the characteristic impedance of 50Ω, in an impedance range where VSWR is 5 or more (a range r1 hatched in FIG. 8), a matching point of the input impedance or the output impedance of radio section 105 and the impedance of antenna 101 exists in a desired frequency.

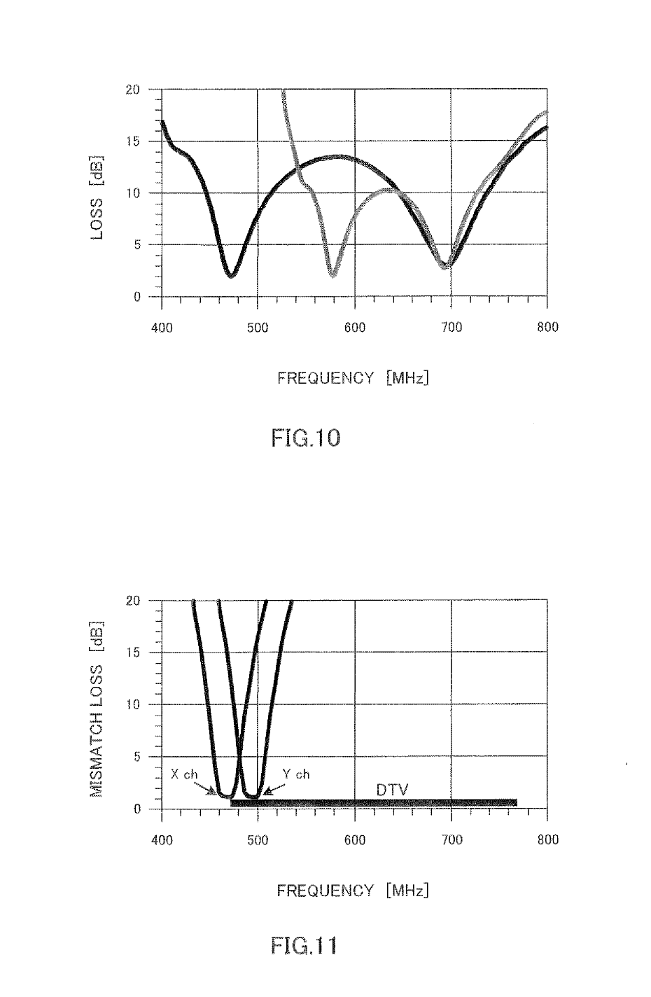

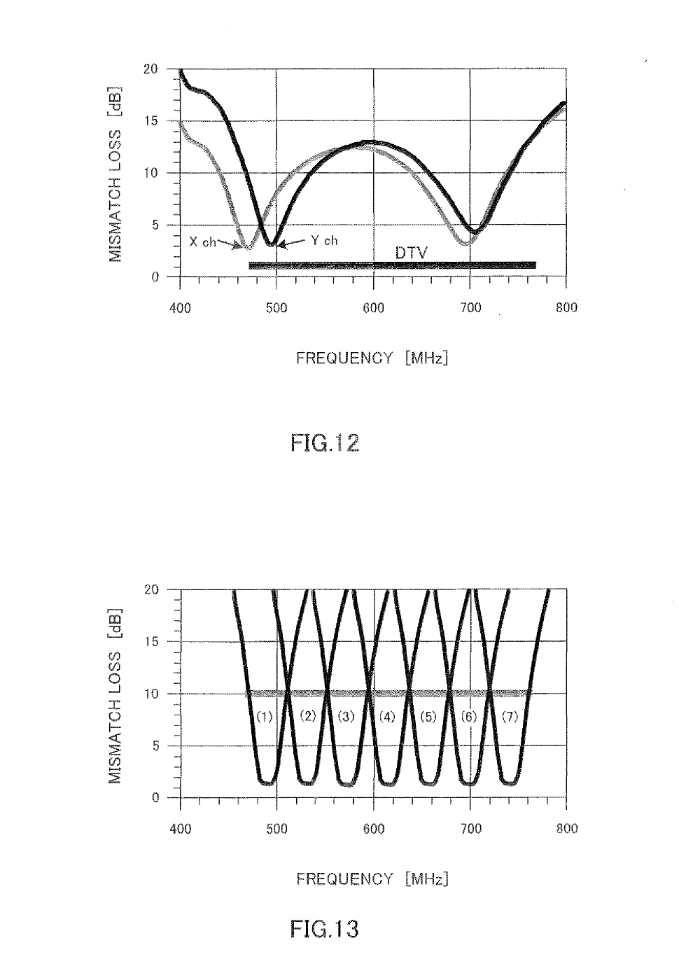

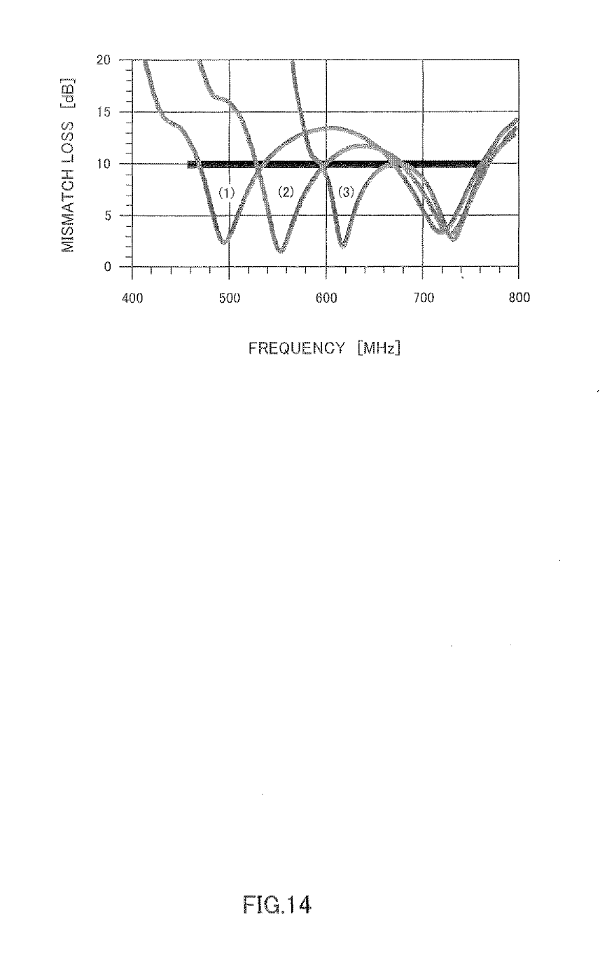

Next, advantages of the present embodiment compared to the conventional art will be described with reference to FIGS. 9 to 14. FIG. 9 is a diagram showing a relationship of frequency and loss in the case of providing a plurality of conventional matching circuits for matching characteristic impedances of 50Ω. FIG. 10 is a diagram showing a relationship of frequency and loss in the present embodiment. FIG. 11 is a diagram showing a conventional relationship of mismatch loss and frequency in viewing two channels of digital television broadcast. FIG. 12 is a diagram showing a relationship of mismatch loss and frequency in viewing digital television broadcasts of two channels in the present embodiment. FIG. 13 is a diagram showing a conventional relationship of the number of matching circuits and bands by which matching can be obtained. FIG. 14 is a diagram showing a relationship of the number of matching circuits 103-1 to 103-n and bands by which matching can be obtained in the present embodiment.

Conventionally, as shown in FIG. 9, since it had been impossible to change the frequency characteristic, it was difficult to appropriately correspond to frequencies with large matching loss and frequencies with small matching loss. On the other hand, as shown in FIG. 10, in the present embodiment it is possible to obtain the matching in the wideband, and it is possible to change at least one of the narrowband frequencies by which the matching can be obtained, from frequency f1 to frequency f2, or from frequency f2 to frequency f1.

Further, conventionally, as shown in FIG. 11, frequency by which the matching of X channel and Y channel can be obtained had been a narrowband. Accordingly, conventionally the sensitivity was significantly deteriorated in the case of a mismatched state in which the impedances change due to an object having approached around the antenna, etc. On the other hand, as shown in FIG. 12, the frequency by which matching of the X channel and the Y channel can be obtained in the present embodiment is a wideband. Accordingly, the sensitivity is prevented from being significantly deteriorated in a case an object approaches near the antenna, etc. Further, the present embodiment can maintain predetermined matching loss (sensitivity) for all of the bands of the digital television broadcast. By this means, it is possible to prevent an extreme degrading in displaying the broadcast for all of the channels, in zapping to sequentially change channels within a short period of time, in scanning all of the channels, or in simultaneously operating two tuners. Further, in the present embodiment, by performing a frequency tuning to coincide a peak of the matching to the frequency of the channel that is primarily being viewed, it is possible to perform an optimal sensitivity distribution for all of the bands of the channel that is primarily being viewed and the digital television broadcast.

Further, as shown in FIG. 13, conventionally in 470 MHz to 770 MHz, which are the entire bands of the digital television broadcast, in order to have mismatching loss of 10 dB or lower, seven matching circuits are needed to obtain matchings (1) to (7). On the other hand, as shown in FIG. 14, under the same condition, the present embodiment merely needs to provide three matching circuits in order to obtain matchings (1) to (3).

Consequently, according to the present embodiment, by providing a plurality of matching circuits that matches so as to have a complex conjugate relationship and differing frequency by which the matching can be performed in each of the matching circuits, it is possible to receive signals with satisfactory sensitivity in the wideband, and change the narrowband by which the receipt can be made with high sensitivity. Therefore, according to the present embodiment, in receiving signals of a plurality of channels such as the digital television broadcast, it is possible to receive the signals of all of the channels with satisfactory sensitivity, and receive the signal of the channel that is primarily viewed, with high sensitivity. Further, according to the present embodiment, in performing matching in the wideband, since it is possible to decrease the number of the matching circuits compared to the conventional art, it is possible to cut down the manufacturing cost, and make the portable radio apparatus compact and thin.

### Embodiment 2

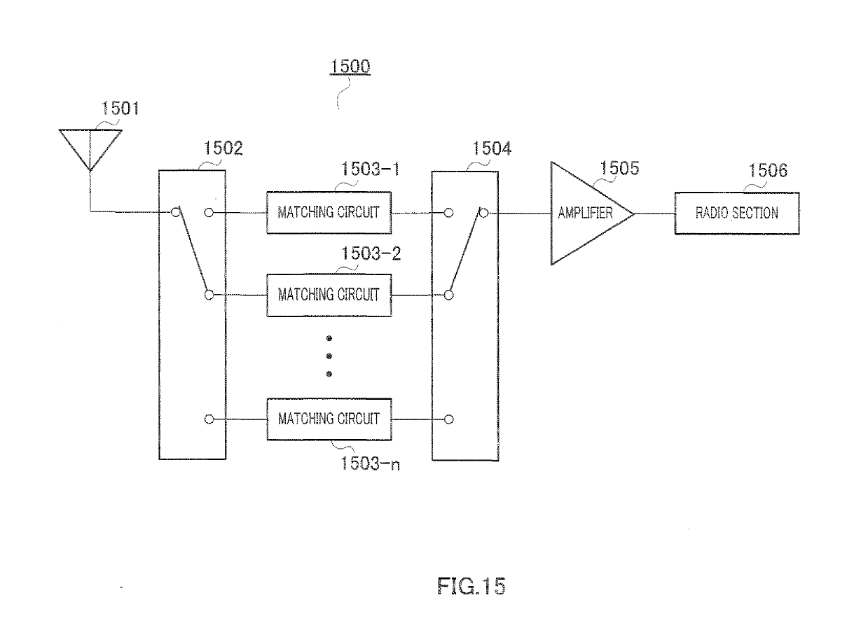

FIG. 15 is a block diagram showing a configuration of portable radio apparatus 1500 of Embodiment 2 of the present invention.

Portable radio apparatus 1500 is configured primarily with antenna 1501, switch section 1502, matching circuits 1503-1 to 1503-n, switch section 1504, amplifier 1505, and radio section 1506. Portable radio apparatus 1500 functions exclusively as a receiver by providing amplifier 1505. Hereinbelow, each configuration will be described in detail.

Antenna 1501 functions e.g. as a monopole antenna, and includes an antenna element with an electrical length of a quarter wavelength or less. Further, antenna 1501 receives a signal from a specific radio system, and outputs the same to switch section 1502.

Switch section 1502 switches output of the signal input from antenna 1501 to specific one of matching circuits 1503-1 to 1503-n.

Matching circuits 1503-1 to 1503-n are connected serially between switch section 1502 and switch section 1504, and match impedances of antenna 1501 and amplifier 1505. Specifically, matching circuits 1503-1 to 1503-n perform matching such that the impedance of antenna 1501 and the input impedance of amplifier 1505 have a complex conjugate relationship. At this occasion, each of matching circuits 1503-1 to 1503-n performs matching so that the complex conjugate relationship can be obtained in the respective, different frequencies. Accordingly, by switching matching circuits 1503-1 to 1503-n, it is possible to vary the frequency by which the complex conjugate relationship can be obtained. Then, matching circuits 1503-1 to 1503-n convert the impedance of the signal input from switch section 1502 and output the same to switch section 1504.

Switch section 1504 selects one of matching circuits 1503-1 to 1503-n, and switches output of the signal input from the selected one of matching circuits 1503-1 to 1503-n to amplifier 1505. Further, switch section 1504 selects one of matching circuits 1503-1 to 1503-n that is identical to the one of matching circuits 1503-1 to 1503-n selected by switch section 1502.

Amplifier 1505 amplifies a signal input from switch section 1504 and outputs the same to radio section 1506. At this occasion, in amplifier 1505, an input impedance is a complex impedance, and an output impedance is a characteristic impedance. Further, amplifier 1505 preferably has high gain and low noise figure (low NF) in the frequency used in portable radio apparatus 1500.

Radio section 1506 obtains data that is superimposed at a specific frequency by demodulating the signal input from amplifier 1505. The configuration of portable radio apparatus 1500 has been described above.

An operation of portable radio apparatus 1500 is identical to that of FIG. 7, and advantages of the present embodiment compared to the conventional art are also identical to those explained in FIGS. 9 to 14. Thus, explanations thereof will not be repeated.

Consequently, according to the present embodiment, by providing a plurality of matching circuits that snatches so as to have a complex conjugate relationship and differing frequency by which the matching can be performed in each of the matching circuits in a portable radio apparatus that is an exclusive receiver, it is possible to receive signals with satisfactory sensitivity in the wideband, and realize the receipt with satisfactory sensitivity even when the desired specific narrowband changes. Further, according to the present embodiment, in performing matching in the wideband, since it is possible to decrease the number of the matching circuits compared to the conventional art, it is possible to cut down the manufacturing cost, and make the portable radio apparatus compact and thin.

### Embodiment 3

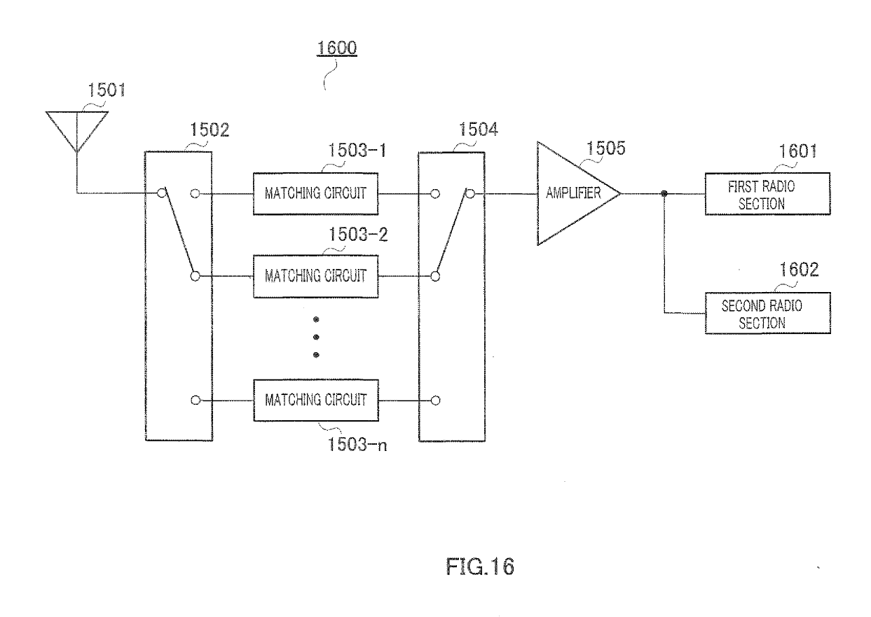

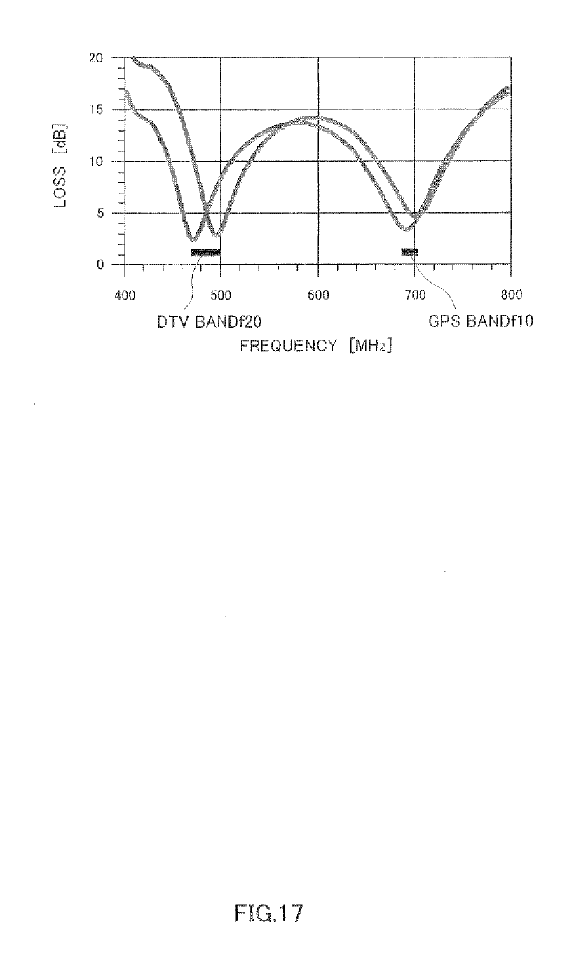

FIG. 16 is a block diagram showing a configuration of portable radio apparatus 1600 of Embodiment 3 of the present invention.

Portable radio apparatus 1600 shown in FIG. 16 omits radio section 1506 and adds first radio section 1601 and second radio section 1602 with respect to portable radio apparatus 1500 in Embodiment 2 shown in FIG. 15. In FIG. 16, parts having identical configurations as in FIG. 15 will be given the same reference signs, and explanation thereof will not be repeated.

Portable radio apparatus 1600 is configured primarily with antenna 1501, switch section 1502, matching circuits 1503-1 to 1503-n, switch section 1504, amplifier 1505, first radio section 1601 and second radio section 1602. Portable radio apparatus 1600 functions exclusively as a receiver by providing amplifier 1505. Hereinbelow, the present embodiment will be described in detail regarding configurations that are different from the above Embodiment 2.

Amplifier 1505 amplifies a signal input from switch section 1504 and outputs the same to first radio section 1601 and second radio section 1602. At this occasion, in amplifier 1505, an input impedance is a complex impedance, and an output impedance is a characteristic impedance. Further, amplifier 1505 preferably has high gain and low noise figure (low NF) in the frequency used in portable radio apparatus 1600.

First radio section 1601 obtains data of a first radio system by demodulating the signal input from amplifier 1505. For example, first radio section 1601 demodulates a signal of a GPS system that is the first radio system and obtains position data.

Second radio section 1602 demodulates a signal input from amplifier 1505, and obtains data of the second radio system that is different from the first radio system. For example, second radio section 1602 demodulates a signal of a digital television broadcast that is the second radio system and obtains data of the digital television broadcast.

FIG. 17 is a diagram showing a relationship of frequency and loss in the first radio system and the second radio system that are capable of receiving signals in portable radio apparatus 1600. In FIG. 17, a case where the first radio system is a GPS system, and the second radio system is a digital television broadcast (DTV) will be described.

As shown in FIG. 17, portable radio apparatus 1600 can obtain matching in a wideband including both of frequency f10 used in the GPS system and frequency f20 used in the digital television broadcast, and can vary the band in which the matching can be performed for the digital television broadcast.

An operation of portable radio apparatus 1600 is identical to that of FIG. 7, and advantages of the present embodiment compared to the conventional art are also identical to those explained in FIGS. 9 to 14. Thus, explanations thereof will not be repeated.

Consequently, according to the present embodiment, by providing a plurality of matching circuits that matches so as to have a complex conjugate relationship and differing frequency by which the matching can be performed in each of the matching circuits in a portable radio apparatus that can use a plurality of radio systems, it is possible to receive signals with satisfactory sensitivity in the wideband, and realize the receipt with satisfactory sensitivity even when the desired specific narrowband changes. Further, according to the present embodiment, in performing matching in the wideband, since it is possible to decrease the number of the matching circuits compared to the conventional art, it is possible to cut down the manufacturing cost, and make the portable radio apparatus compact and thin.

In the present embodiment, although an exclusive receiver was exemplified by providing an amplifier, the present invention is not limited hereto, and may be configured to be capable of performing both the sending and receiving by omitting the amplifier.

### Embodiment 4

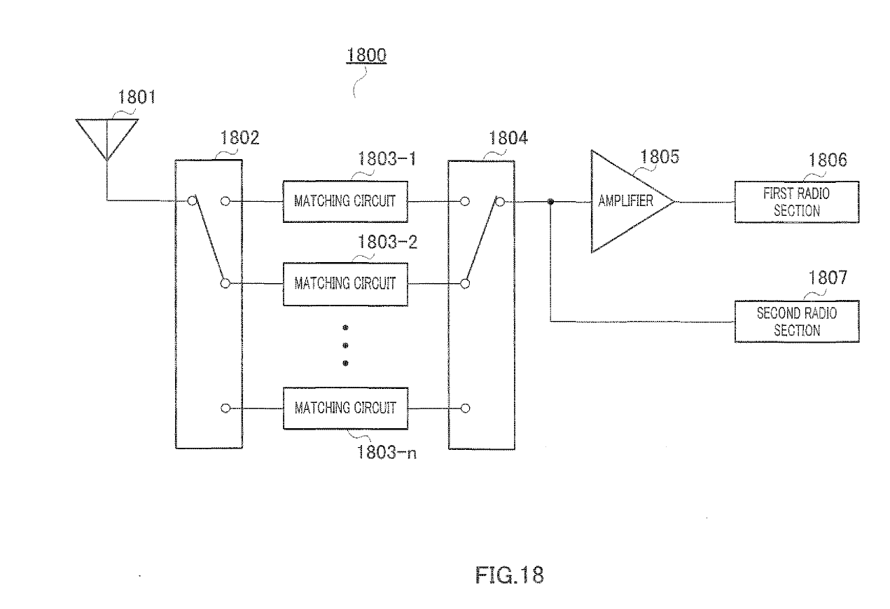

FIG. 18 is a block diagram showing a configuration of portable radio apparatus 1800 of Embodiment 4 of the present invention.

Portable radio apparatus 1800 is configured primarily with antenna 1801, switch section 1802, matching circuits 1803-1 to 1803-n, switch section 1804, amplifier 1805, first radio section 1806, and second radio section 1807. Hereinbelow, each configuration will be described in detail.

Antenna 1801 functions e.g. as a monopole antenna, and includes an antenna element with an electrical length of a quarter wavelength or less. Further, antenna 1801 receives signals from the first radio system and the second radio system, and outputs the same to switch section 1802. Further, antenna 1801 sends a signal of the second radio system input from switch section 1802.

Switch section 1802 switches output of the signal input from antenna 1801 to specific one of matching circuits 1803-1 to 1803-n. Further, switch section 1802 selects one of matching circuits 1803-1 to 1803-n, and switches output of the signal input from the selected one of matching circuits 1803-1 to 1803-n to antenna 1801.

Matching circuits 1803-1 to 1803-n are connected serially between switch section 1802 and switch section 1804, and match impedances of antenna 1801 and amplifier 1805, as well as antenna 1801 and second radio section 1807. Specifically, matching circuits 1803-1 to 1803-n perform matching such that the impedance of antenna 1801 and the input impedance of amplifier 1805 have a complex conjugate relationship, and the impedance of antenna 1801 and the input impedance of second radio section 1807 have a complex conjugate relationship. At this occasion, each of matching circuits 1803-1 to 1803-n performs matching so that the complex conjugate relationship can be obtained in the respective, different frequencies. Accordingly, by switching matching circuits 1803-1 to 1803-n, it is possible to vary the frequency by which the complex conjugate relationship can be obtained. Further, matching circuits 1803-1 to 1803-n convert the impedance of the signal input from switch section 1802 and output the same to switch section 1804. Similarly, matching circuits 1803-1 to 1803-n match the impedance of antenna 1801 and the output impedance of second radio section 1807 to have the complex conjugate relationship, convert the impedance of the signal input from switch section 1804 and output the same to switch section 1802.

Switch section 1804 selects one of matching circuits 1803-1 to 1803-n, and switches output of the signal input from the selected one of matching circuits 1803-1 to 1803-n to amplifier 1805 and second radio section 1807. Further, switch section 1804 switches output of the signal input from second radio section 1807 to specific one of matching circuits 1803-1 to 1803-n. Further, switch section 1804 selects one of matching circuits 1803-1 to 1803-n that is identical to the one of matching circuits 1803-1 to 1803-n selected by switch section 1802.

Amplifier 1805 amplifies a signal input from switch section 1804 and outputs the same to first radio section 1806. At this occasion, in amplifier 1805, an input impedance is a complex impedance, and an output impedance is a characteristic impedance. Further, amplifier 1805 preferably has high gain and low noise figure (low NF) in the frequency used in portable radio apparatus 1800.

First radio section 1806 obtains data of the first radio system by demodulating the signal input from amplifier 1805. For example, first radio section 1806 demodulates a signal of the digital television broadcast that is the first radio system and obtains data of the digital television broadcast.

Second radio section 1807 obtains data of the second radio system by demodulating the signal input from switch section 1804. Further, second radio section 1807 modulates the signal to superimpose data at the frequency of the second radio system, and outputs the modulated signal to switch section 1804. At this occasion, at second radio section 1807, the input impedance and the output impedance at switch section 1804 side are complex impedances and are at the same time high impedances. For example, second radio section 1807 demodulates a signal of the GPS system that is the second radio system and obtains position data. The configuration of portable radio apparatus 1800 has been described above.

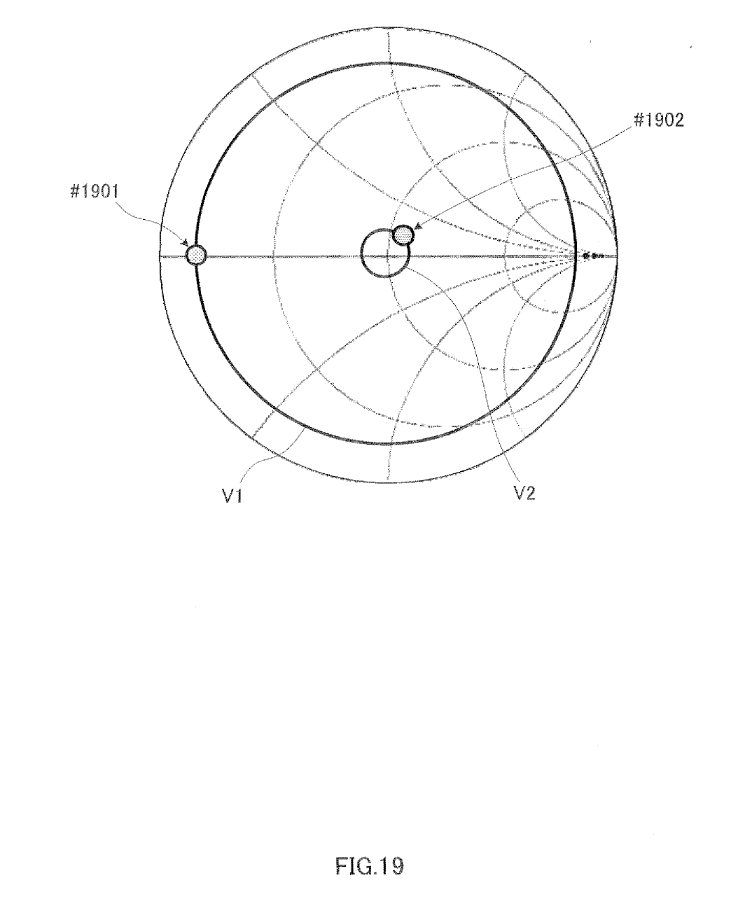

FIG. 19 is a diagram showing changes in the impedance matching point of the first radio system and the second radio system.

As shown in FIG. 19, the change v1 of the matching point #1901 of the first radio system is larger compared to the change v2 of the matching point #1902 of the second radio system.

An operation of portable radio apparatus 1800 is identical to that of FIG. 7, and advantages of the present embodiment compared to the conventional art are also identical to those explained in FIGS. 9 to 14. Thus, explanations thereof will not be repeated. Further, a diagram showing a relationship of frequency and loss in the first radio system and the second radio system that are capable of receiving signals in portable radio apparatus 1800 is identical to FIG. 17, so the explanation thereof will not be repeated.

Consequently, according to the present embodiment, by providing a plurality of matching circuits that matches so as to have a complex conjugate relationship and differing frequency by which the matching can be performed in each of the matching circuits in a portable radio apparatus that can use a plurality of radio systems, it is possible to receive signals with satisfactory sensitivity in the wideband, and make the receipt with satisfactory sensitivity even when the desired specific narrowband changes. Further, according to the present embodiment, in performing matching in the wideband, since it is possible to decrease the number of the matching circuits compared to the conventional art, it is possible to cut down the manufacturing cost, and make the portable radio apparatus compact and thin.

In the present embodiment, although an exclusive receiver was exemplified for the first radio system by providing an amplifier, the present invention is not limited hereto, and may be configured to be capable of performing both the sending and receiving for the first radio system by omitting the amplifier.

### Embodiment 5

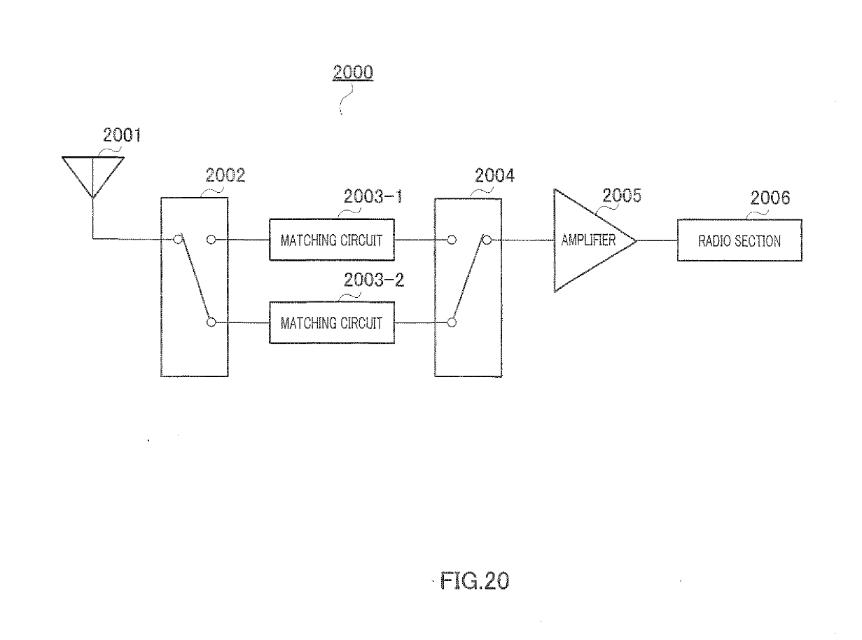

FIG. 20 is a block diagram showing a configuration of portable radio apparatus 2000 of Embodiment 5 of the present invention.

Portable radio apparatus 2000 is configured primarily with antenna 2001, switch section 2002, matching circuits 2003-1 and 2003-2, switch section 2004, amplifier 2005, and radio section 2006. Portable radio apparatus 2000 functions exclusively as a receiver by providing amplifier 2005. Hereinbelow, each configuration will be described in detail.

Antenna 2001 functions e.g. as a monopole antenna, and includes an antenna element with an electrical length of a quarter wavelength or less. Further, antenna 2001 receives a signal from a specific radio system, and outputs the same to switch section 2002.

Switch section 2002 switches output of the signal input from antenna 2001 to matching circuit 2003-1 or 2003-2.

Matching circuit 2003-1 is connected serially between switch section 2002 and switch section 2004, and matches impedances of antenna 2001 and amplifier 2005. Specifically, matching circuit 2003-1 performs matching such that the impedance of antenna 2001 and the input impedance of amplifier 2005 have a complex conjugate relationship. At this occasion, matching circuit 2003-1 performs matching so as to have the complex conjugate relationship in frequency that is different from matching circuit 2003-2. Accordingly, by switching matching circuit 2003-1 and matching circuit 2003-2, it is possible to vary the frequency by which the complex conjugate relationship can be obtained. Further, matching circuit 2003-1 can vary the frequency by which the complex conjugate relationship can be obtained. Then, matching circuit 2003-1 converts the impedance of the signal input from switch section 2002 and output the same to switch section 2004. The detailed configuration of matching circuit 2003-1 will be described later.

Matching circuit 2003-2 is connected serially between switch section 2002 and switch section 2004, and matches impedances of antenna 2001 and amplifier 2005. Specifically, matching circuit 2003-2 performs matching such that the impedance of antenna 2001 and the input impedance of amplifier 2005 have the complex conjugate relationship. At this occasion, matching circuit 2003-2 performs matching so as to have the complex conjugate relationship in frequency that is different from matching circuit 2003-1. Accordingly, by switching matching circuit 2003-2, it is possible to vary the frequency by which the complex conjugate relationship can be obtained. Then, matching circuit 2003-2 converts the impedance of the signal input from switch section 2002 and outputs the same to switch section 2004.

Switch section 2004 selects matching circuit 2003-1 or matching circuit 2003-2, and switches output of the signal input from the selected matching circuit 2003-1 or matching circuit 2003-2 to amplifier 2005. Further, switch section 2004 selects one of matching circuits 2003-1 to 2003-n that is identical to the one of matching circuits 2003-1 to 2003-n selected by switch section 2002.

Amplifier 2005 amplifies a signal input from switch section 2004 and outputs the same to radio section 2006. At this occasion, in amplifier 2005, an input impedance is a complex impedance, and an output impedance is a characteristic impedance. Further, amplifier 2005 preferably has high gain and low noise figure (low NF) in the frequency used in portable radio apparatus 2000.

Radio section 2006 obtains data that is superimposed at a specific frequency by demodulating the signal input from amplifier 2005.

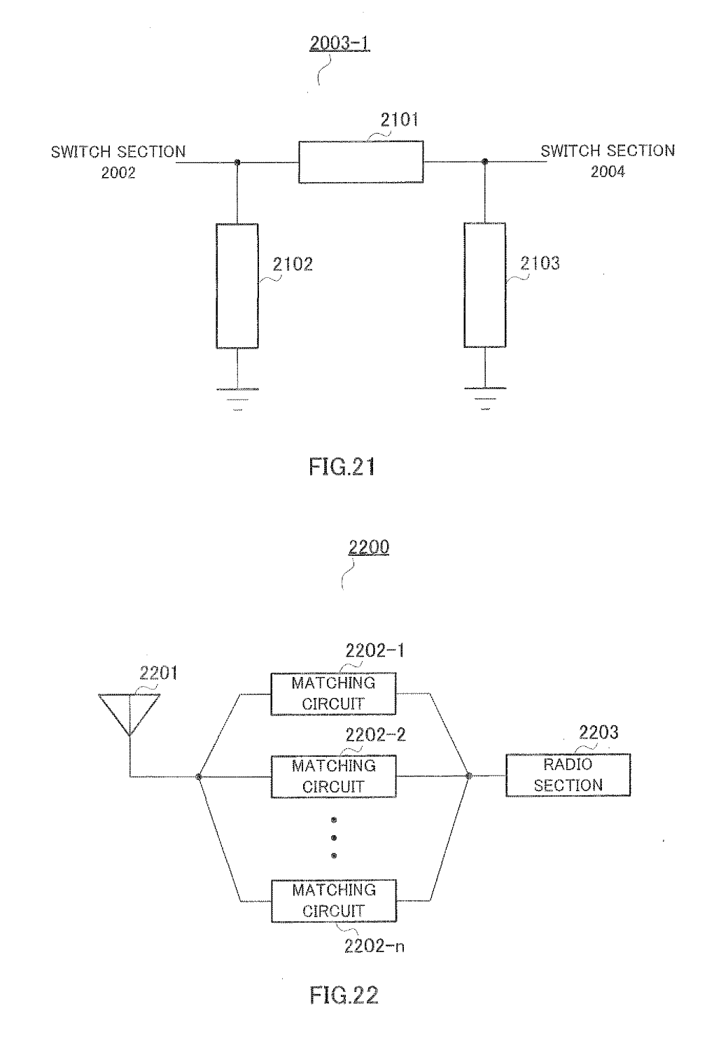

Next, the configuration of matching circuit 2003-1 will be described with reference to FIG. 21. FIG. 21 is a block diagram showing the configuration of matching circuit 2003-1.

As shown in FIG. 21, matching circuit 2003-1 is configured with element 2101, element 2102, and element 2103. Elements 2101 to 2103 are inductors or capacitors.

Element 2101 has its one end connected to switch section 2002 and its other end connected to switch section 2004. Further, element 2101 is configured with a variable inductor or a variable capacitor (variable condenser or varactor diode, etc.).

Element 2102 is connected by ground connection in parallel between switch section 2002 and element 2101.

Element 2103 is connected by ground connection in parallel between element 2101 and switch section 2004.

An operation of portable radio apparatus 2000 is identical to that of FIG. 7, and advantages of the present embodiment compared to the conventional art are also identical to those explained in FIGS. 9 to 14. Thus, explanations thereof will not be repeated.

According to the present embodiment, in addition to the effect of the above-mentioned Embodiment 1, it is possible to further decrease the number of the matching circuits by varying the frequency by which the matching can be obtained in at least one matching circuit, thus it is possible to further cut down the manufacturing cost, and make the portable radio apparatus more compact and thinner.

In the present embodiment, although just one matching circuit that can vary the frequency by which the matching can be obtained was provided, the present embodiment is not limited hereto; and a plurality of matching circuits may vary the frequency by which the matching can be obtained. Further, in the present embodiment, although the number of the matching circuits was two, the present embodiment is not limited hereto; and it is possible to determine an arbitrary number of the matching circuits.

### Embodiment 6

FIG. 22 is a block diagram showing a configuration of portable radio apparatus 2200 of Embodiment 6 of the present invention.

Portable radio apparatus 2200 is configured primarily with antenna 2201, matching circuits 2202-1 to 2202-n, and radio section 2203. Hereinbelow, each configuration will be described in detail.

Antenna 2201 functions e.g. as a monopole antenna, and includes an antenna element with an electrical length of a quarter wavelength or less. Further, antenna 2201 receives a signal from a specific radio system, and outputs the same to matching circuits 2202-1 to 2202-n. Further, antenna 2201 sends signals from matching circuits 2202-1 to 2202-n.

Matching circuits 2202-1 to 2202-n are connected serially between antenna 2201 and radio section 2203, and match impedances of antenna 2201 and radio section 2203. Specifically, matching circuits 2202-1 to 2202-n perform matching such that the impedance of antenna 2201 and the input impedance of radio section 2203 have a complex conjugate relationship. At this occasion, each of matching circuits 2202-1 to 2202-n performs matching by switching using an internal switch based on matching loss information of each of matching circuits 2202-1 to 2202-n e.g. in all of the channels in the digital television broadcast that is stored in a switch control section, etc. that is not shown so that the complex conjugate relationship can be obtained in the respective, different frequencies. By switching matching circuits 2202-1 to 2202-n, it is possible to vary the frequency by which the complex conjugate relationship can be obtained. Further, matching circuits 2202-1 to 2202-n convert the impedance of the signal input from antenna 2201 and output the same to radio section 2203. Similarly, matching circuits 2202-1 to 2202-n match the impedance of antenna 2201 and the output impedance of radio section 2203 to have the complex conjugate relationship, convert the impedance of the signal input from radio section 2203 and output the same to antenna 2201. The detailed configuration of matching circuits 2202-1 to 2202-n will be described later.

Radio section 2203 obtains data that is superimposed at a specific frequency by demodulating the signal input from matching circuits 2202-1 to 2202-n. Further, radio section 2203 modulates the signal to superimpose data at the specific frequency, and outputs the modulated signal to matching circuits 2202-1 to 2202-n. At this occasion, at radio section 2203, the input impedance and the output impedance at matching circuits 2202-1 to 2202-n side are complex impedances and are at the same time high impedances.

Next, the configuration of matching circuits 2202-1 to 2202-n will be described. In the explanation of the configuration of matching circuits 2202-1 to 2202-n hereinbelow, only matching circuit 2202-1 will be described; since the configuration of matching circuits 2202-2 to 2202-n is identical to that of matching circuit 2202-1, the explanation of the configuration thereof will not be repeated.

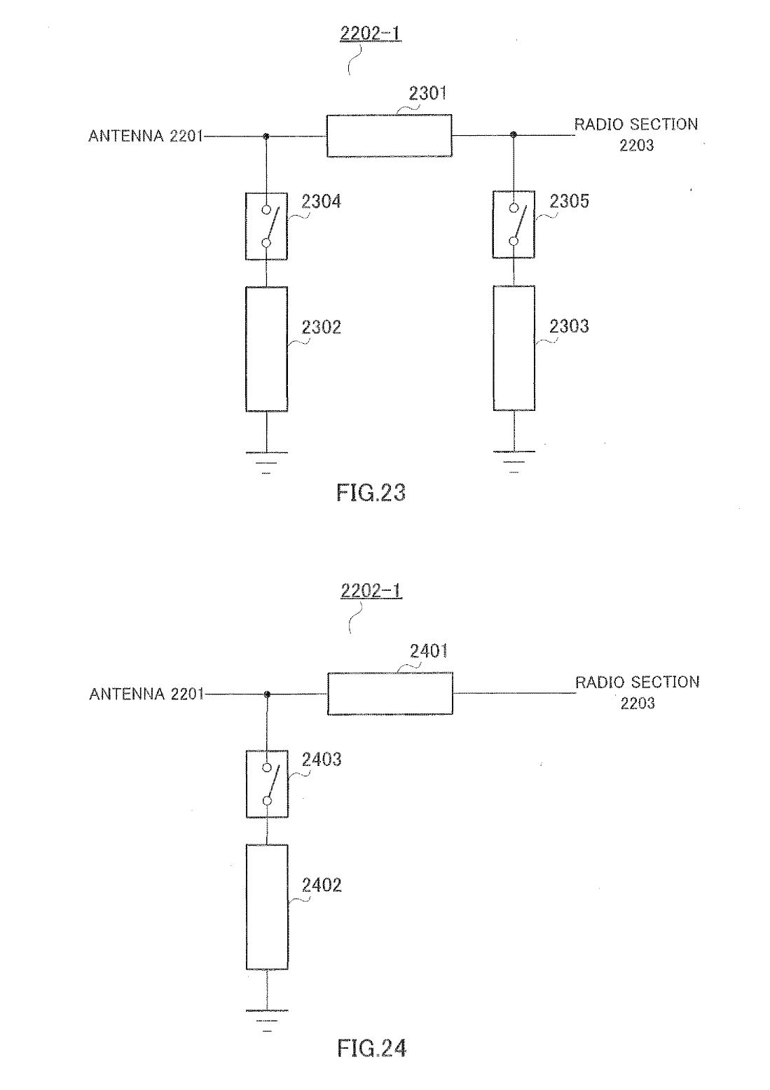

FIG. 23 is a block diagram showing the first example of the configuration of matching circuit 2202-1.

As shown in FIG. 23, matching circuit 2202-1 is configured with element 2301, element 2302, element 2303, switch section 2304, and switch section 2305. Elements 2301 to 2303 are inductors or capacitors.

Element 2301 has its one end connected to antenna 2201 and its other end connected to radio section 2203.

Element 2302 is connected by ground connection in parallel between antenna 2201 and element 2301.

Element 2303 is connected by ground connection in parallel between element 2301 and radio section 2203.

Switch section 2304 connects and disconnects an electrical connection between antenna 2201, element 2301 and element 2302.

Switch section 2305 connects and disconnects an electrical connection between element 2301, radio section 2203 and element 2303.

FIG. 24 is a block diagram showing the second example of a configuration of matching circuit 2202-1.

As shown in FIG. 24, matching circuit 2202-1 is configured with element 2401, element 2402, and switch section 2403. Elements 2401 and 2402 are inductors or capacitors.

Element 2401 has its one end connected to antenna 2201 and its other end connected to radio section 2203.

Element 2402 is connected by ground connection in parallel between antenna 2201 and element 2401.

Switch section 2403 connects and disconnects an electrical connection between antenna 2201, element 2401 and element 2402. Specifically, switch section 2403 turns on if matching is performed by matching circuit 2202-1, and turns off if matching is not performed by matching circuit 2202-1.

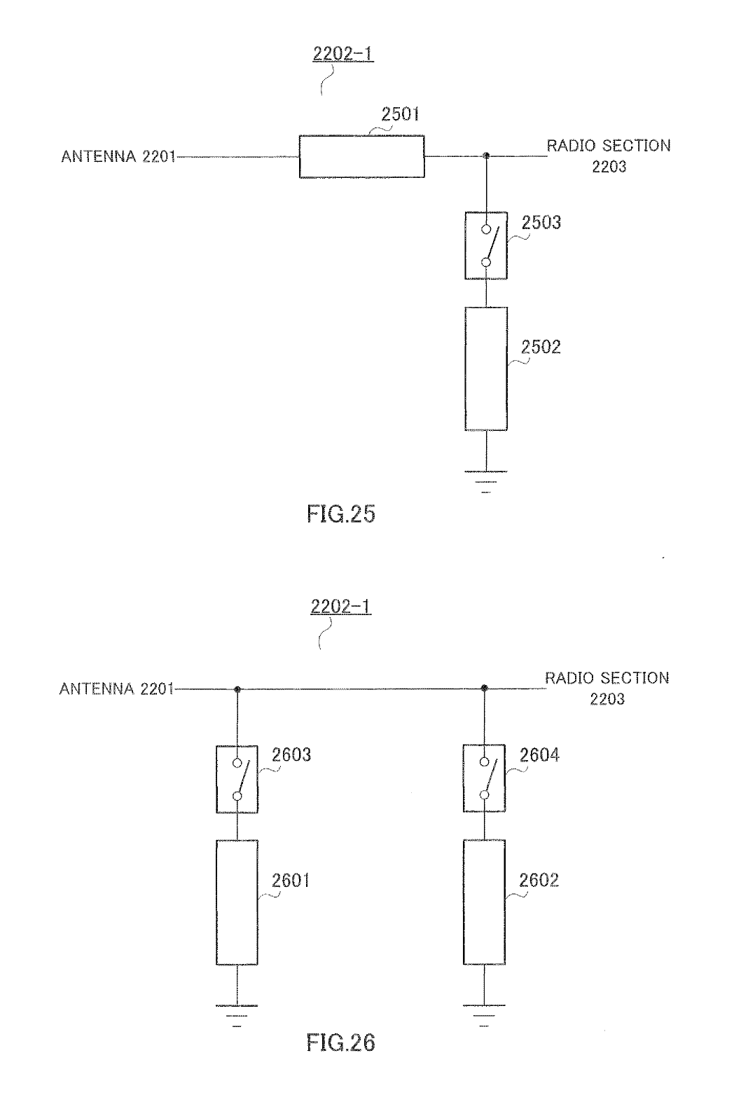

FIG. 25 is a block diagram showing the third example of a configuration of matching circuit 2202-1.

As shown in FIG. 25, matching circuit 2202-1 is configured with element 2501, element 2502, and switch section 2503. Elements 2501 and 2502 are inductors or capacitors.

Element 2501 has its one end connected to antenna 2201 and its other end connected to radio section 2203.

Element 2502 is connected by ground connection in parallel between element 2501 and radio section 2203.

Switch section 2503 connects and disconnects an electrical connection between element 2501, radio section 2203 and element 2502. Specifically, switch section 2503 turns on if matching is performed by matching circuit 2202-1, and turns off if matching is not performed by matching circuit 2202-1

FIG. 26 is a block diagram showing the fourth example of a configuration of matching circuit 2202-1.

As shown in FIG. 26, matching circuit 2202-1 is configured with element 2601, element 2602, switch section 2603, and switch section 2604. Elements 2601 and 2602 are inductors or capacitors.

Element 2601 is connected by ground connection in parallel between antenna 2201 and radio section 2203.

Element 2602 is connected by ground connection in parallel between antenna 2201 and radio section 2203, and is connected by ground connection in parallel with element 2601.

Switch section 2603 connects and disconnects an electrical connection between antenna 2201, radio section 2203, and element 2601. Specifically, switch section 2603 turns on if matching is performed by matching circuit 2202-1, and turns off if matching is not performed by matching circuit 2202-1

Switch section 2604 connects and disconnects an electrical connection between antenna 2201, radio section 2203, and element 2602. Specifically, switch section 2604 turns on if matching is performed by matching circuit 2202-1, and turns off if matching is not performed by matching circuit 2202-1.

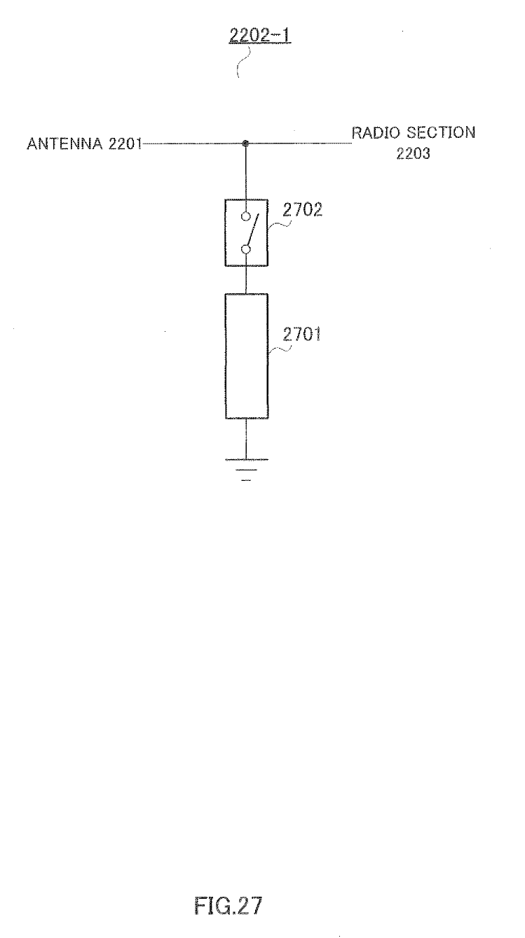

FIG. 27 is a block diagram showing the fifth example of a configuration of matching circuit 2202-1.

As shown in FIG. 27, matching circuit 2202-1 is configured with element 2701 and switch section 2702. Element 2701 is an inductor or a capacitor.

Element 2701 is connected by ground connection in parallel between antenna 2201 and radio section 2203.

Switch section 2702 connects and disconnects an electrical connection between antenna 2201, radio section 2203, and element 2701.

Specifically, switch section 2702 turns on if matching is performed by matching circuit 2202-1, and turns off if matching is not performed by matching circuit 2202-1. The configuration of portable radio apparatus 2200 has been described above.

An operation of portable radio apparatus 2200 is identical to that of FIG. 7, and advantages of the present embodiment compared to the conventional art are also identical to those explained in FIGS. 9 to 14. Thus, explanations thereof will not be repeated.

Consequently, according to the present embodiment, by providing a plurality of matching circuits that matches so as to have a complex conjugate relationship and differing frequency by which the matching can be performed in each of the matching circuits, it is possible to receive signals with satisfactory sensitivity in the wideband, and realize the receipt with satisfactory sensitivity even when the desired specific narrowband changes. Further, according to the present embodiment, in performing matching in the wideband, since it is possible to decrease the number of the matching circuits compared to the conventional art, it is possible to cut down the manufacturing cost, and make the portable radio apparatus compact and thin.

In the present embodiment, although an amplifier was not provided, the present invention is not limited hereto, and may be configured as an exclusive receiver by serially providing the amplifier between the matching circuit and the radio section. Further, in the present embodiment, of the plurality of matching circuits, it is possible to vary the frequency by which the matching can be obtained in at least one matching circuit. Further, in the present embodiment, although a case of dealing with one radio system has been described, the present embodiment is not limited hereto; and it is possible to deal with a plurality of radio systems by providing a plurality of radio sections.

The disclosure of Japanese Patent Application No. 2009-159839 filed on Jul. 6, 2009, including the specification, drawings and abstract, is incorporated herein by reference in its entirety.

### INDUSTRIAL APPLICABILITY

The portable radio apparatus of the present invention can obtain matching especially in the wideband, as well as can vary the frequency by which the matching is enabled in the narrowband.

1-13. (canceled)

14. A portable radio apparatus comprising:
an antenna that receives signals of a plurality of channels of digital television broadcast;
a radio section that performs demodulation of the signals of the plurality of channels that are received by the antenna;
a plurality of matching circuits, each of which is connected between the antenna and the radio section, performs matching such that an impedance of the antenna and an impedance of the radio section have a complex conjugate relationship, and is provided for each of the different frequency bands in which the matching is to be performed; and
a selecting section that selects the matching circuit in which a matching loss of a signal of a specific channel received by the antenna becomes smaller than matching losses of signals of channels other than the specific channel and a total of the matching loss for each of the signals of the plurality of channels that are received by the antenna becomes minimum.

15. The portable radio apparatus according to claim 14, further comprising an amplifying section that amplifies a signal that has been matched by the matching circuit,
wherein the radio section performs demodulation of the signal amplified by the amplifying section.

16. The portable radio apparatus according to claim 14, wherein the antenna receives signals of a plurality of radio systems including the digital television broadcast,
the radio section performs demodulation of the signals of the plurality of radio systems that are received by the antenna, and
the matching circuit performs the matching of the signals of the plurality of radio systems.

17. The portable radio apparatus according to claim 16, further comprising an amplifying section that amplifies only signals of a part of the radio systems from among the signals of the plurality of radio systems to which the matching has been performed by the matching circuit,
wherein the radio section performs the demodulation of the signals of the part of the radio systems that are amplified by the amplifying section.

18. The portable radio apparatus according to claim 14, wherein the matching circuit is capable of changing the frequency band in which the matching is to be performed.

19. The portable radio apparatus according to claim 14, wherein the antenna includes an antenna element that is a quarter wavelength or less.

20. The portable radio apparatus according to claim 14, wherein the radio section performs, in addition to the demodulation, modulation of a signal to be sent by the antenna,
the selecting section selects the matching circuit for performing the matching in the case of sending the signals by the antenna, in addition to a case of receiving the signals of the plurality of channels by the antenna.

21. A portable radio apparatus comprising:
an antenna that receives signals of a plurality of channels of digital television broadcast;
a radio section that performs demodulation of the signals of the plurality of channels that are received by the antenna; and
a plurality of matching circuits, each of which is connected between the antenna and the radio section, includes a switch section that opens and closes the circuit, performs matching such that an impedance of the antenna and an impedance of the radio section have a complex conjugate relationship by closing the switch section, performs the matching, and is provided for each of the different frequency bands in which the matching is to be performed,
wherein the matching is performed by closing the switch section of the matching circuit in which a matching loss of a signal of a specific channel received by the antenna becomes smaller than matching losses of signals of channels other than the specific channel and a total of the matching loss for each of the signals of the plurality of channels that are received by the antenna becomes minimum.
